(19) United States
(12) Patent Application Publication
(10) Pub. No.: US 2006/0209997 A1
(43) Pub. Date: Sep. 21, 2006

(54) Amplifiers with cutoff circuit to avoid overloading cellular network sites

(75) Inventors: V. Alan Van Buren, Cedar City, UT (US); Volodymyr Skrypnyk, Hurricane, UT (US); Patrick L. Cook, St. George, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Wilson Electronics, St. George, UT (US)

(21) Appl. No.: 11/449,225

(22) Filed: Jun. 8, 2006

(51) Int. Cl. H04L 27/08

(52) U.S. Cl. 375/345

(57) ABSTRACT

A cellular network amplifier for reducing interference in a surrounding cellular network. The cellular network amplifier includes a communication device for receiving an uplink signal from a handset and a first variable gain module for applying an amplification factor to the uplink signal. The amplified uplink signal is transmitted to a base station by an antenna. The antenna also receives a downlink signal transmitted from the base station enroute to the handset. The downlink signal is analyzed by a control circuit, which determines a value of the amplification factor applied to the uplink and downlink signals based on the level of the downlink signal. The value of the amplification factor is determined such that the signal transmitted from the antenna does not introduce interference into the surrounding cellular network.

### CROSS-REFERENCE TO RELATED APPLICATIONS

Not applicable.

### BACKGROUND OF THE INVENTION

1. The Field of the Invention

The present invention relates to cellular network amplifiers. In particular, embodiments of the present invention relate to systems and methods for dynamically controlling a cellular network amplifier to provide an optimal gain level for preventing the introduction of interference into a cellular network.

2. The Relevant Technology

In recent years, cellular (“cell” or “mobile”) telephones have dramatically increased in popularity. A growing number of people are relying exclusively on cell phones, and are abandoning their traditional land line telephone services in favor of the convenience of the mobility of cell phones. This increase in cell phone reliance has resulted in the need for reliable cellular signal coverage over a wider area.

Use of cell phones in areas having a weak signal often result in dropped calls which can be annoying for the cell phone user and expensive for the wireless service provider. Dropped calls typically result when the signal between the cell phone and the base station is lost. A loss of signal may occur for a number of reasons, including interference due to buildings or mountains, or an increase in distance between the cell phone and the base station. Therefore, a particular need exists to increase the reliability of cell phones near large buildings and in vehicles driving long distances in remote areas.

Attempts have been made to increase the reliability of cell phones through use of cell phone signal boosters, also known as cellular network amplifiers. Cellular network amplifiers receive the cellular signal sent from a base station, amplify the signal, and retransmit the signal to one or more cell phones. Similarly, the cellular network amplifier receives the signals from one or more cell phones, amplifies the signals, and retransmits the signals to the base station.

Cellular network amplifiers are typically placed in relatively close proximity to one or more cell phones, and serve the purpose of increasing the level of the signals being transmitted to and from the cell phones so that the cell phones can communicate with base stations that would otherwise be out of range. Some amplifiers are configured to be integrated with the cell phone itself or with a cell phone cradle. Alternatively, other amplifiers are configured to be placed in, a separate location from the cell phone itself. For example, a cellular network amplifier may be placed in a user's vehicle, or in or near a building that would otherwise have poor reception.

Conventional cell phone signal boosters apply constant gain levels to the signal passing through the amplifier. In general, signal boosters typically increase signal power to the maximum allowable power as permitted by the relevant governing agency. Producing this maximum regulatory allowable power can often be beneficial where the signal booster is located a long distance from the base station. However, if the signal booster is located within close proximity to a base station and the amplifier gain is too high, the signals transmitted from the signal booster may cause interference to be introduced in the surrounding cellular network by overloading the base station. Furthermore, over-amplification may also result in an unstable amplifier, causing unwanted oscillation. Both of these conditions will likely cause harmful interference to the base station and the cell phones connected to it.

The tendency for many cell phone signal boosters to cause interference creates a significant problem for wireless service providers by causing degradation to the overall quality of their service. Since wireless service providers often evaluate and approve cellular network amplifiers before they are used in the providers' systems, the providers are unlikely to approve signal boosters that cause interference.

### BRIEF SUMMARY OF THE INVENTION

The present invention relates to systems and methods for preventing the introduction of interference into a cellular network by signals transmitted from a cellular network amplifier. The cellular network amplifier amplifies cellular signals by a sufficient or variable amount to successfully retransmit the signals between a base station and a handset or cellular phone. However, the cellular network amplifier also ensures that the signals are not amplified to an extent that causes interference to be introduced into a surrounding cellular network. In particular, embodiments of the present invention prevent the cellular network amplifier from transmitting signals that overload a cell phone base station.

In one embodiment, the cellular network amplifier is configured with a communication device for communicating cellular signals to and from one or more handsets. The uplink signals received from the handset are amplified by a variable gain module, thereby generating an adjusted uplink signal. The amount that the variable gain module amplifies the cellular signal is determined by an amplification factor, which is established by a control circuit. The control circuit makes the determination of the amplification factor based on a number of factors. Particularly, the cellular network amplifier receives a downlink signal from the base station via an antenna. The control circuit measures the level of the downlink cellular signal. The level of the downlink signal provides the control circuit with an indication of the level at which the uplink signal should be retransmitted in order to successfully reach the base station without introducing interference into the surrounding cellular network.

The amplification factor may be switched between a zero and a non-zero value. Alternatively, the value of the amplification factor may be proportional to the measurements of the cellular signals as determined by the control circuitry or it may be a different intermediate value.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of a cellular communications system;

FIG. 2 is a schematic of a unidirectional cellular network amplifier;

FIGS. 3A, 3B, 4A, and 4B are schematics of bidirectional cellular network amplifiers; and

FIGS. 5A and 5B are flow diagrams of methods for reducing the interference introduced by a cellular network amplifier into the surrounding cellular network.

### DETAILED DESCRIPTION OF THE PREFERRED EMBODIMENTS

Embodiments of the invention relate to amplifiers that enhance the ability of a device such as a cellular telephone to communicate in a wireless network. The present invention extends to a cellular network amplifier that dynamically adjusts the gain applied to a cellular signal. One embodiment of the network amplifier variably adjusts its gain as needed. The ability to automatically adjust the gain applied to a cellular signal can prevent the amplifier from generating signals that may interfere with the operation of a cellular network. As described above, an overly strong cellular signal can overload a cell site, which results in interference to the cellular network and adversely impacts users of the cellular network.

Embodiments of the network amplifier can be integrated with cellular telephones (or other devices) or connect with a cellular telephone. The amplifier acts as an intermediary between a base station (or other cell site) and a cellular telephone. Signals generated by the cellular telephone are amplified and retransmitted by the network amplifier. The network amplifier also receives signals from the base station and transmits them to the cellular telephone.

The network amplifier receives an uplink signal from a handset, and a downlink signal from a base station via an antenna. A control circuit determines the level of the downlink signal and adjusts an amplification factor based on the level of the downlink signal. The adjusted amplification factor is applied to the uplink signal, and the resulting signal is transmitted via the antenna to the base station. The control circuit adjusts the amplification factor such that when the resulting signal is transmitted via the antenna, it is transmitted at a level that substantially eliminates the introduction of interference into the surrounding cellular network, and in particular, such that the transmitted signal does not overload the base station.

For purposes of the present invention, the following definitions are provided. The term “cellular” and “cellular network” refer to a wireless telephone network that connects radio transmissions between a mobile phone and a system of multiple cell sites, each including an antenna and a base station, to a mobile telephone switching office, and ultimately to the public wireline telephone system. Cellular calls are transferred from base station to base station as a user travels from cell to cell. One of skill in the art can appreciate that embodiments of the invention can be applied to other wireless networks as well.

By way of example, the phrase “cell phone” refers to a wireless device that sends and receives messages using radiofrequency signals in the 800-900 megahertz (MHz) portion of the radiofrequency (RF) spectrum, and the phrase “PCS phone” (personal communication system phone) refers to a wireless device that uses radiofrequency signals in the 1850-1990 MHz portion of the RF spectrum. For purposes of simplicity, as used herein, the terms “cell phone” and “handset” are intended to cover both “cell phone” and “PCS phone”, as defined above, as well as other handheld devices. Likewise, as used herein, the phrase “cellular signal” refers to signals being transmitted both in the cell phone spectrum (i.e., 800-900 MHz) and in the PCS spectrum (i.e., 1850-1990 MHz). One of skill in the art can appreciate that embodiments of the invention are not limited to operation in these spectrums, but can be applied in other portions of the frequency spectrum as well.

“Cell site” and “base station” are used herein interchangeably. Cell site and base station are defined as the location where the wireless antenna and network communications equipment is placed. A cell site or base station typically includes a transmitter/receiver, antenna tower, transmission radios and radio controllers for maintaining communications with mobile handsets within a given range.

The phrase “uplink signal” refers to the transmission path of a signal being transmitted from a handset to a base station. The phrase “downlink signal” refers to the transmission path of a signal being transmitted from the base station to the handset. The phrases “uplink signal” and “downlink” signal are not limited to any particular type of data that may be transmitted between a handset and a base station, but instead are simply used to specify the direction in which a signal is being transmitted.

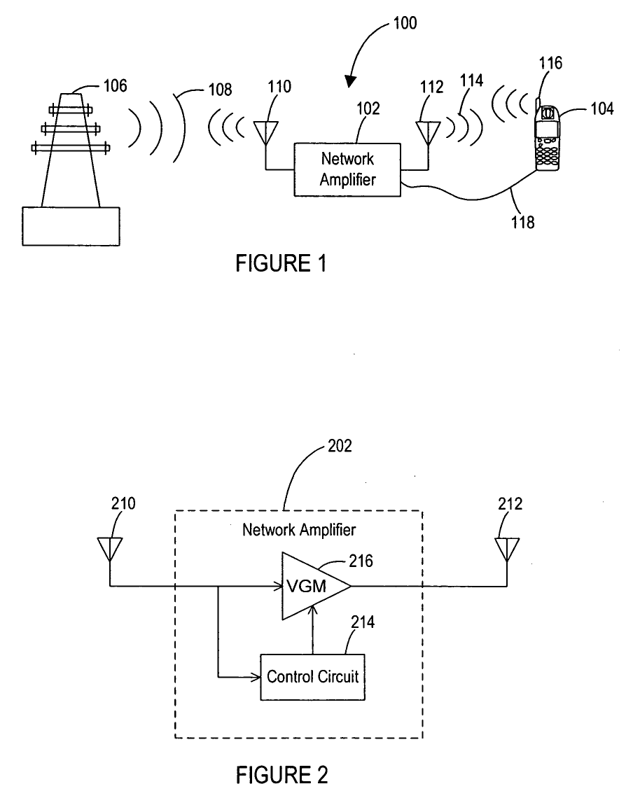

FIG. 1 shows an exemplary communications system 100. The communications system 100 may be a cellular telephone wireless network or other wireless network. In this example, a network amplifier 102 amplifies the signals transmitted between a base station 106 and a handset 104. In a typical system, the network amplifier 102 is located in close proximity to the handset 104 in comparison to the distance to the base station 106. The base station 106 transmits a signal 108 into the surrounding air, which is attenuated for various reasons known to one of skill in the art as it travels outward from the base station 106. An antenna 110 receives the signal 108 and converts the signal into an electrical equivalent.

The network amplifier 102 amplifies the electrical signal and communicates the amplified signal to the handset 104 in one of two ways. First, the amplifier 102 may retransmit the electrical signal from a second antenna 112 as an amplified RF signal 114. The amplified signal 114 is received by an antenna 116 of handset 104, which processes the signal and ultimately communicates the appropriate content to a user of handset 104. As previously indicated, the network amplifier 102 may be an integral part of the handset 104.

Similarly, the handset 104 may communicate content to the network amplifier 102 by transmitting an RF signal from the antenna 116, which is ultimately received by the antenna 112. The network amplifier 102 amplifies the received signal and retransmits the signal using the antenna 110. The transmitted signal is received by the base station 106, which may perform a number of operations on the signal, as determined by the wireless service provider.

FIG. 2 illustrates a generalized unidirectional network amplifier 202 configured for producing an optimal gain level, in accordance with the present invention. The network amplifier 202 is connected to an antenna 210 which is configured to receive a cellular signal transmitted by a base station. The antenna 210 converts the received signal into an electrical signal. The electrical signal is received by a variable gain module (VGM) 216, which applies an amplification factor to the electrical signal. In one embodiment, the electronic signal is communicated via a second antenna 212, which transmits the adjusted electrical signal as an RF signal, to be received by one or more handsets or other devices.

The variable gain module 216 is controlled by a control circuit 214. The control circuit 214 receives the electrical signal from the antenna 210, and based on the properties of the electrical signal, determines an optimal amplification factor that should be applied to the electrical signal. The control circuit 214 provides a control signal to the variable gain module 216. The control signal instructs the gain module 216 as to the amplification factor that should be applied to the electrical signal. Many factors may be accounted for when calculating the required amplification factor. Factors include, by way of example and not limitation, the level or strength of the electrical signal and whether there is any indication that the network amplifier 202 is oscillating or overloading the cellular network in any way.

The amplification factor, in one embodiment, is a multiplier that is applied to the electrical signal. The amplification factor can result in either an amplified or attenuated output signal. In other words, where the amplification factor is less than one, the amplified adjusted signal will have a lower amplitude than the original electrical signal. Conversely, when the amplification factor is greater than one, the amplified adjusted signal will have a greater amplitude than the original electrical signal.

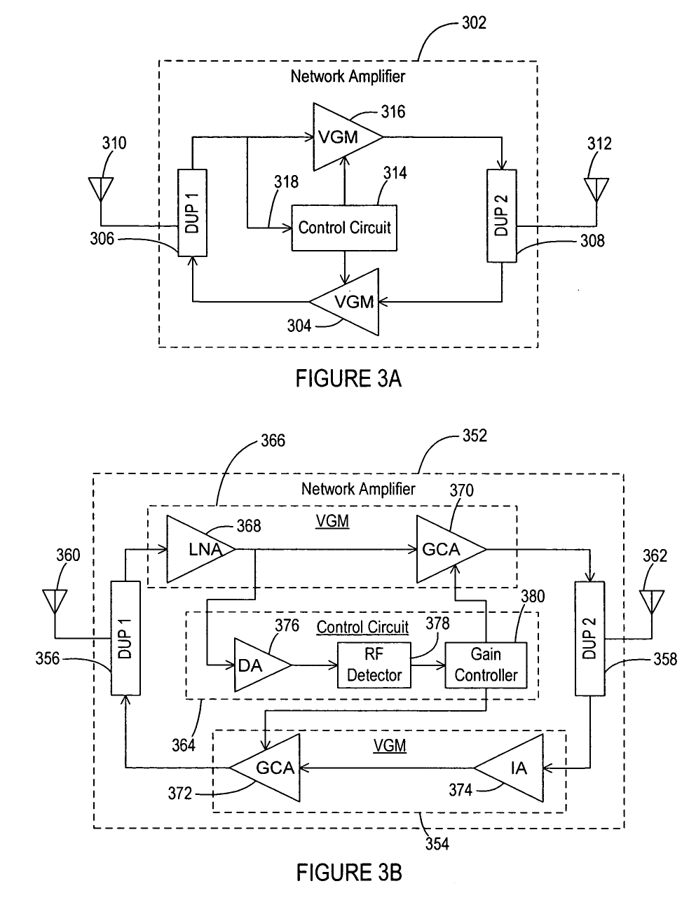

FIG. 3A illustrates one embodiment of a bidirectional network amplifier 302 configured to control the amplification of cellular signals being transmitted between a base station and a handset. Similar to network amplifier 202 illustrated in FIG. 2, a cellular signal is received from a base station at the antenna 310 and is passed to both a control circuit 314 and a variable gain module 316. Control circuit 314 controls the amplification factor of variable gain module 316. The amplified signal may be connected to a second antenna 312, which transmits a cellular signal to at least one handset.

Bidirectional cellular amplifier 302 is also configured to receive signals from one or more handsets, amplify those signals, and retransmit the signals to a base station. A signal from a handset may be received by antenna 312. The signal is routed to a second variable gain module 304, which applies an amplification factor to the signal. The amplification factor is determined and controlled by control circuitry 314.

In order to allow antennas 310 and 312 to simultaneously transmit and receive signals, duplexers (DUP) 306 and 308 are provided by way of example. A duplexer is defined as an automatic electrical device that permits the use of the same antenna for concurrently transmitting and receiving. More generally, a duplexer is a three port device with one common port “A” and two independent ports “B” and “C”. Ideally, signals are passed from A to B and from C to A, but not between B and C. For example, the duplexer 306 receives an RF signal from a base station and converts the signal into a first electrical signal, which is routed to the inputs of the variable gain device 316 and the control circuitry 314. The duplexer 306 simultaneously receives a second electrical signal from the output of the variable gain module 304, and causes this signal to be transmitted as an RF signal via the antenna 310.

The control circuitry 314 may be configured to accomplish various objectives when determining the amplification factors to be applied to the variable gain modules 304 and 316. Exemplary objectives include, but are not limited to, i) setting the power level at which the signals are transmitted at a sufficient level to ensure that the signals reach a target destination; and ii) ensuring that the signals transmitted from the network amplifier are transmitted at a power level that substantially eliminates the interference that would otherwise be introduced into the surrounding cellular network.

First, the control circuitry 314 establishes the amplification factors of the variable gain modules 304 and 316 so that the resultant signals are transmitted with sufficient power to adequately reach a target destination, such as a handset or a base station. Where the cellular signal received at the antenna 310 has undergone significant attenuation, e.g., when the target destination is located a long distance away from the network amplifier 302, the amplification factor is increased. Conversely, where the cellular signal received at the antenna 310 is at a sufficiently high level, a lower amplification may be established for variable gain modules 316 or 304.

Second, the control circuitry 314 ensures that the signals transmitted from the network amplifier are transmitted at a power level that substantially eliminates the interference that would otherwise be introduced into the surrounding cellular network. Many cellular networks, such as CDMA systems, are configured such that the power level transmitted by each handset in the network is determined by the base station. When communication between a handset and a base station is initiated, a “handshake” occurs between the handset and base station, and the base station instructs the handset as to the power at which the handset should transmit. If the base station determines that the signal from the handset is too strong, it will instruct the handset to reduce the power level of the transmitted signal. The CDMA system is designed so that all of the signals coming into the base station are of approximately the same power. If one signal arrives at the base station at a power level that is significantly higher than the others, it can potentially overpower the base station and cause interference with the other handsets in communication with the base station.

Therefore, the control circuitry 314 may determine the maximum amplitude or power level that can be transmitted by antenna 310 to substantially eliminate interference. Interference is considered to be substantially eliminated when signals are transmitted from the network amplifier 302 without causing harmful effects to the surrounding cellular network. For example, interference is substantially eliminated where the signals are transmitted without overpowering the base station, or otherwise interfering with other handsets within the cellular network in a way that degrades their performance. The control circuitry 314 may establish the amplification factors applied to variable gain modules to either attenuate or amplify the electrical signals in order to achieve this objective.

The determination of the amplification factor values may be dependent on whether the signals received from the base station via antenna 310 exceed a threshold value. The threshold value may be a predetermined set value, or may be a variable that is not established until the control circuitry 314 makes a determination. For example, if after analyzing the strength of the signals received via antenna 310, the control circuitry 314 determines that the distance between cellular network amplifier 302 and the target base station is substantial, the control circuitry 314 may establish higher threshold values than if the base station or handset were within close proximity. The higher threshold values would allow a greater amplification factor to be applied to the signals so that the transmitted signals will reach their target destination. Because of the substantial distance over which the signals must traverse, the signals will arrive at the target destination (e.g., a base station) without exceeding an appropriate power level, and will therefore not overpower the base station or cause substantial interference with signals transmitted from other handsets.

In the embodiment of FIG. 3A, the amplification factors applied to the variable gain modules 316 and 304 are both determined based on the attributes of the signal received from a base station via the antenna 310. The input signal from the base station is received by the control circuitry 314 from the antenna 310 at the connection 318, and radiated to a handset via antenna 312. The control circuitry 314 can make a number of determinations based on the attributes of the base station signal. First, the control circuitry 314 can determine the amplitude level of the signal from the base station. Based on the amplitude, the control circuitry can determine an adequate amplification factor for the variable gain module 316 to enable communication of the received signal to a handset. Second, the amplitude of the signal received from the base station is also an indicator of the amplitude required to successfully transmit a signal back to the base station via the antenna 310. For example, if the control circuitry 314 measures a low amplitude of the first electrical signal, it is likely that the signal transmitted by the base station has been attenuated due to a long distance or obstructions between the base station and the network amplifier 302. Therefore, it can determine the amplification factor required by the variable gain module 304 so that the second electrical signal originating from the handset is retransmitted with sufficient power to reach the base station.

FIG. 3B illustrates another embodiment of a network amplifier. Similar to the network amplifier illustrated in FIG. 3A, the network amplifier 352 includes an antenna 360, a first and second duplexer (DUP 1) 356 and (DUP 2) 358, respectively, a first and second variable gain module 354 and 366, (included within the dashed boxes), control circuitry 364 (indicated by the dashed box), and an antenna 362 or connector. More particularly, the variable gain module 366 includes a low noise amplifier (LNA) 368 and a gain controlled amplifier (GCA) 370. The gain module 354 contains an intermediate amplifier (IA) 374 and a gain controlled amplifier (GCA) 372. The gain controlled amplifiers 370 and 372 may include voltage controlled amplifiers, digitally controlled programmable gain amplifiers, and the like. The input of the control circuitry 364 is received from the output of the low noise amplifier 368 for providing an adequate signal to be used for determining the amplification factors.

The control circuitry 364 includes, in this example, a detector amplifier (DA) 376, an RF detector 378, and a gain controller 380. Detector amplifier 376 amplifies the input signal to a level sufficient for driving RF detector 378. The RF detector 378 produces an output which is indicative of the signal level produced by the output of the low noise amplifier 368. As described above, the control circuitry 364 may be configured to accomplish various objectives when determining the amplification factors to be applied to the variable gain modules 366 and 354.

For example, based on the output of the RF detector 378, the gain controller 380 may increase the amplification factors applied to gain controlled amplifier 370 or 372 to ensure that the resultant signals have sufficient power and amplitude to provide satisfactory results. Where the input signal received by the network amplifier 352 by means of antenna 360 is sufficiently weak, the gain controller 380 typically sets the amplification factors to a maximum available value.

Furthermore, the gain controller 380 may decrease the amplification factors where it is determined that the signal levels would otherwise overload the base station, or otherwise cause harmful interference to the cellular network. In one embodiment, when the output of the RF detector 378 exceeds a predetermined threshold, the gain controller 380 turns off the gain controlled amplifier 372 and/or 370. In other words, the control circuit 364 switches the amplification factor to a zero value when the level of the cellular signal received from the base station exceeds a predetermined value, and switches the amplification factor to a non-zero value when the signal level falls below the predetermined value.

In another embodiment, the gain controller 380 does not simply switch the gain controlled amplifiers on or off, but instead adjusts the amplification relative to the level of the signal received from the base station. In other words, the control circuit 364 sets the value of the amplification factors as a function of the level of the cellular signal received from the base station.

In one embodiment, the amplification factors applied to the gain controlled amplifiers 370 and 372 are equivalent. However, in another embodiment, the amplification factors applied to the gain controlled amplifiers 370 and 372 need not be the same. Although the gain controller 380 may only receive a single input signal, the gain controller may be configured to have two independent output signals to account for the unique requirements of the gain controlled amplifiers 370 and 372. In another embodiment, the changes made to the first and second amplification factors occur in identical incremental amounts. Therefore, even where the values of the amplification factors may not be identical, the changes made to the first amplification factor may match the changes made to the second amplification factor.

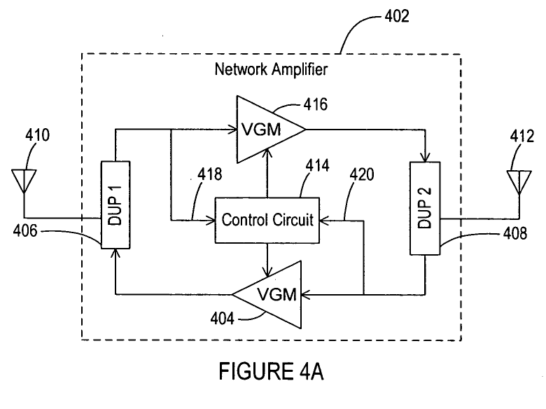

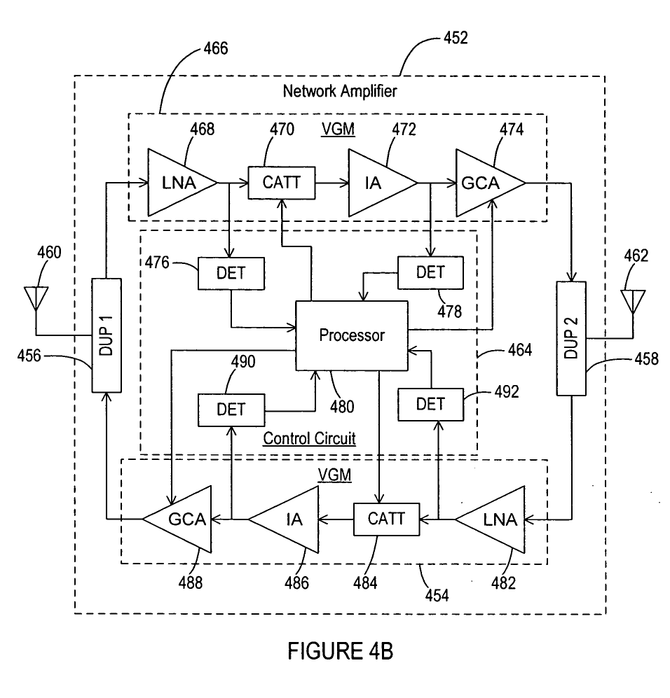

FIG. 4A illustrates another embodiment of a network amplifier 402 configured to generate optimum gain levels for the transmission of signals including radio or cellular type signals. The embodiment illustrated in FIG. 4A includes first and second antennas 410 and 412, respectively, first and second duplexers (DUP 1) 406 and (DUP 2) 408, respectively, first and second variable gain modules (VGM) 404 and 416, respectively, and control circuitry 414. The antenna 412 is configured for transmitting cellular signals to at least one handset, and for receiving cellular signals from the same. The control circuitry 414 may include analog circuits, digital circuits, or a combination of both.

The control circuitry 414 controls the amplification factors applied to the variable gain modules 404 and 416. Similar to the control circuitry 314 of the embodiment illustrated in FIG. 3A, the control circuitry 414 may be configured to ensure that sufficient gain is applied to the cellular signals to ensure that the signals reach their target destination, and further ensure that the power level at which the signals are sent does not overload the base station.

Because the network amplifier 402 communicates with handsets via antenna 412, and is not directly connected to the handsets via a connector, the amplification factor applied to variable gain module 404 may be more accurately calculated using the characteristics of the signals received from the handsets, as well as from the base station. In this example, the control circuitry 414 receives input signals from the antenna 410 and the antenna 412 (i.e., connections 418 and 420, respectively). By monitoring the characteristics of the signals received from the handset and from the signals received from the base station, the control circuitry 414 can make more accurate determinations regarding the level at which signals should be transmitted to the base station and to the handsets. For example, if the control circuitry 414 determines that the signal received from a handset via antenna 412 has been significantly attenuated, it can be implied that the handset is located a significant distance from the location of the network amplifier 402. Therefore, the control circuitry will make the determination that a higher level of gain is needed so that the signal transmitted from antenna 412 to the handset will have adequate power to ultimately reach the handset.

In addition to accomplishing the above objectives, the control circuitry 414 may further be configured to substantially eliminate oscillation that may be generated by the network amplifier 402. When multiple antennas (e.g., antennas 410 and 412) are employed, embodiments of the invention ensure that the network amplifier 402 does not begin to oscillate which will likely cause harmful interference to a base station and/or the handsets connected to it and preclude effective communications. Oscillation in the network amplifier 402 is typically caused by feedback that may occur between the two antennas 410 and 412. If the gains produced by variable gain modules 404 and 416 are sufficiently low, the network amplifier 402 will remain stable. However, when the gains exceed a threshold level and/or if the antennas are physically too close to each other, the system becomes unstable, and begins to oscillate.

The introduction of oscillation by an amplifier into a cellular network can be a serious problem. Network amplifiers are often installed by an end user instead of by a wireless service provider. Consequently, the wireless service provider cannot easily predict or mitigate the interference introduced by oscillation. The oscillating signals produced by the network amplifier 402 can extend beyond the intended target (i.e., the base station or handset) and intermingle with other signals. As a result, an oscillating signal from one cellular network amplifier can disrupt the communication links between a base station and the handsets connected to it.

For example, a common use for the network amplifier 402 is to amplify cellular signals being transmitted to and from a building. In an in-building scenario, the network amplifier 402 may be configured such that the antenna 412 is located within the interior of the building, and the antenna 410 is located on the exterior of the building. Cellular signals transmitted from a base station are received at the external antenna 410, amplified by variable gain module 404 in accordance with the amplification established by control circuitry 414, and retransmitted by the internal antenna 412. Because the signals received from the base station have frequencies that are close to the signals transmitted by the antenna 412, a potential for feedback exists, thus increasing the likelihood of an oscillating circuit. This likelihood is particularly high where the antennas 410 and 412 are located within close proximity to one another, and where the amplification of the variable gain modules 404 and 416 are set at a high level.

Therefore, the control circuitry 414 may be configured to prevent the occurrence of oscillation within the network amplifier 402. The control circuitry 414 achieves this objective by analyzing the signal levels of the inputs 418 and 420. When an oscillating condition exists, the levels of the signals received via the antennas 410 and 412 are typically significantly higher than when the network amplifier 402 is operating at normal conditions.

When the control circuitry 414 detects conditions that may indicate oscillation, the control circuitry 414 may eliminate the oscillating condition in a number of ways. First, the control circuitry 414 may turn off the entire network amplifier 402 so that the handsets communicate directly to the base station instead of through the amplifier 402. Alternatively, the control circuitry 414 may first attempt to only turn off the variable gain modules 404 or 416.

In an alternative embodiment, the control circuitry 414 may decrement the amplification of the variable gain modules 404 or 416 until the oscillation ceases. By decrementing the amplification factors instead of immediately shutting off the network amplifier, the oscillation can be eliminated while still maintaining some level of gain. This process can be applied to the variable gain modules 404 and 416, simultaneously together, one at a time, or any other manner.

The network amplifier 402 may include a visual display for indicating the existence of an oscillating condition. For example, the visual display may include a light emitting diode (LED), or the like. The display may indicate that an oscillation has occurred in the past (but has since been eliminated by either shutting down the amplifier 402 or by reducing the gain of one of the variable gain modules 404 and/or 416) and may indicate the presence of an existing oscillation. After a user is aware of an oscillating condition, the user may reposition the antennas 410 and/or 412 so that the amplifier 402 may produce a larger gain without the introduction of oscillation.

FIG. 4B illustrates another embodiment of a network amplifier. Similar to FIG. 4A, the network amplifier 452 includes first and second antennas 460 and 462, respectively, first and second duplexers 456 and 458, respectively, first and second variable gain modules, indicated by dotted boxes 454 and 466, respectively, and control circuitry, indicated by dotted box 464.

The first and second variable gain modules 454 and 466 may include low noise amplifiers (LNA) 468 and 482, controllable attenuators (CATT) 470 and 484, intermediate amplifiers (IA) 472 and 486, and gain controlled amplifiers (GCA) 474 and 488. The electrical signals generated by antennas 460 and 462 are initially amplified by the low noise amplifiers 468 and 482. The resultant signals may be attenuated by controllable attenuators 470 and 484. The amount of attenuation is dependant on first and second attenuation factors, as determined by the control circuitry 464. The resultant signal is amplified and buffered by intermediate amplifiers 472 and 486. The resultant signal is amplified by the gain controlled amplifiers 474 and 488 by an amount dependant on gain factors as determined by the control circuitry 464.

The control circuitry 464 includes, in this example, at least two detectors 478 and 490 that detect the signals at the output of the intermediate amplifiers 472 and 486. The results are provided to processor 480, which determines amplification factors for the variable gain modules 466 and 454. Each amplification factor includes a gain factor for the gain controlled amplifier 474 or 488, and an attenuation factor for the controllable attenuator 470 or 484. The processor 480 may increase or decrease the gain applied to the electrical signals while attempting to ensure that the transmitted signals reach their target destination (i.e., a handset or a base station). In the present embodiment, gain is increased by increasing the gain factor applied to the gain controlled amplifier 474 or 488. The processor 480 thus controls the gain applied to the gain controlled amplifier 474 or 488.

The processor 480 may further be configured to reduce or substantially eliminate interference that may be caused, by way of example, from overloading the base station. As described above, when the amplifier 452 emits signals at excessive power levels, the base station may be overloaded, causing interference with the overall cellular network. Therefore, the processor 480 monitors the signal levels as provided by detector 478 or 490 to determine whether the signal levels exceed a threshold value. When the threshold is exceeded, the processor 480 may reduce the overall gain by either increasing the attenuation factor applied to the controllable attenuator 470 or 484, or by decreasing the gain factor applied to the gain controlled amplifier 474 or 488.

The processor 480 may similarly be configured to reduce or eliminate interference that may be caused from oscillation. When the detector 478 or 490 provides readings that indicate an oscillating condition, the processor 480 may incrementally change the attenuation factors applied to the controllable attenuators 470 and 484 and/or the gain factors applied to the gain controlled amplifier 474 or 488 in order to reduce the overall gain produced by the variable gain module 466 or 454. The attenuation factor may be incrementally increased, and the gain factor may be incrementally decreased. After each incremental change in the attenuation and/or gain factors, processor 480 analyzes the signal levels to determine if the oscillating condition still exists. If the amplifier 452 is still oscillating, the processor 480 increments the gain and/or attenuation factors again, and repeats the process until the oscillation has been eliminated, or at least reduced to an acceptable level.

In one embodiment of the present invention, additional detectors 476 and 492 are provided for the purpose of quickly eliminating any oscillation that may be generated by the network amplifier 452. While detectors 478 and 490 can be used to eliminate or reduce any oscillation by incrementally changing the gain and attenuation factors, as described in the previous embodiment, this mechanism may be too slow to preclude interference. Unfortunately, significant disruption can be caused to a cellular network within a very short period of time when an amplifier is oscillating. Therefore, detectors 476 and 492 are employed to provide a safety mechanism that can immediately eliminate oscillation when the oscillation exceeds a predetermined level. The detectors 476 and 492 provide the processor 480 with a reading of the signal level at the output of the low noise amplifier 468 or 482. If this reading exceeds a predetermined level, the processor 480 immediately shuts down all elements of the network amplifier 452 that are causing the oscillation to occur. The user is notified of the oscillation condition, and the user may reposition the antennas 460 and 462 in an attempt to eliminate the condition creating the oscillation. In this manner, disruption due to high levels of oscillation are prevented.

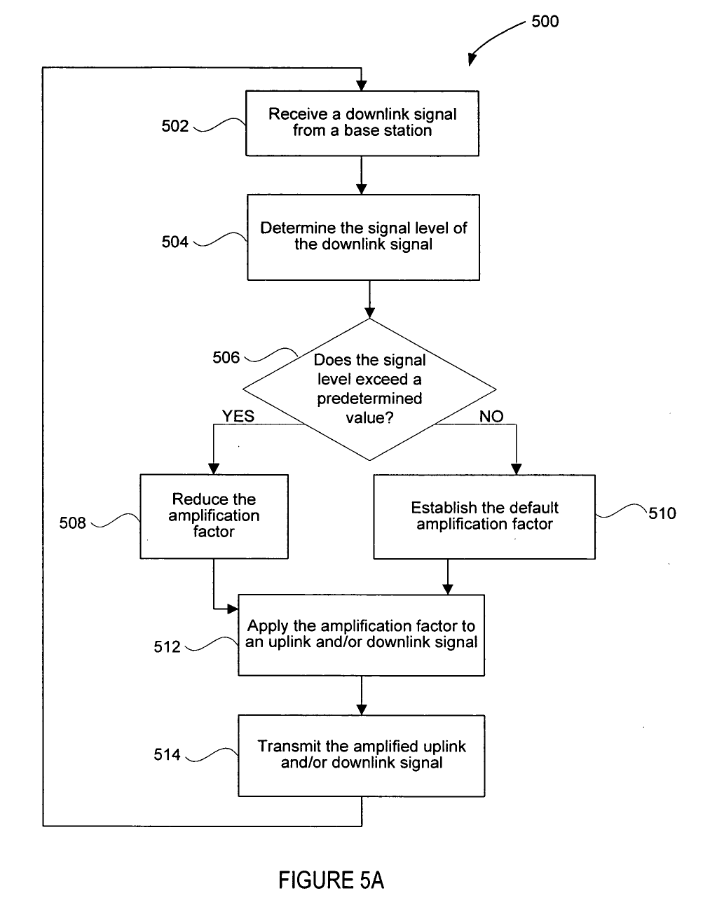

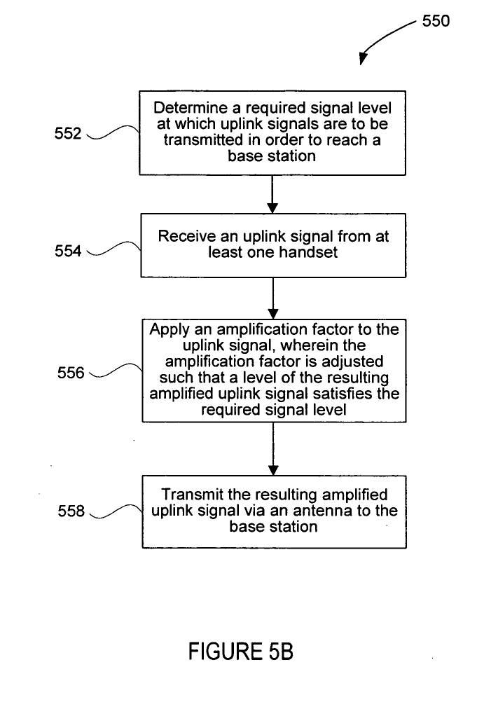

FIGS. 5A and 5B illustrate flow diagrams for exemplary embodiments of the present invention. The following description of FIGS. 5A and 5B may occasionally refer to FIGS. 1-4B. Although reference may be made to a specific element from these figures, such elements are used for illustrative purposes only and are not meant to limit or otherwise narrow the scope of the present invention unless explicitly claimed.

FIG. 5A illustrates a flow diagram for a method 500 of reducing interference introduced by a network amplifier, the cellular network amplifier having at least one variable gain module for applying an amplification factor to a cellular signal. Method 500 includes receiving 502 the cellular signal at the network amplifier from a base station. As shown in FIG. 1, the signal may be received by an externally connected antenna 110.

Method 500 also includes, determining 504 the signal level of the cellular signal received from the base station. As explained in FIGS. 4A and 4B, the level of the cellular signal may be determined by control circuitry 414, or 464. A determination 506 is then made as to whether the level of the cellular signal exceeds a predetermined signal value. As described above, the predetermined level may be selected based on a determination of the maximum level at which a signal (after amplification) may be transmitted without introducing interference into the surrounding cellular network.

In the event that the signal level exceeds the predetermined signal value, the method further includes reducing 508 the amplification factor to be applied to the cellular signal. Conversely, if the signal level does not exceed the predetermined signal value, the method includes establishing 510 the amplification factor so that the transmitted amplified cellular signal has sufficient power to be transmitted to the handset. However, establishing 510 the amplification factor is not necessarily required, because a default amplification factor may automatically be applied to the cellular signal if its signal level did not exceed the predetermined signal value.

After the determination is made as to the needed amplification factor, the resultant amplification factor is applied 512 to the cellular signal. As illustrated in FIGS. 4A and 4B, the amplification factor may be applied to the cellular signal using the variable gain modules 416 or 466. The amplified signal is transmitted 514 via an antenna to the handset.

FIG. 5B illustrates an exemplary flow diagram for another method 550 of reducing interference introduced by a network amplifier. The method 550 begins with determining 552 a required signal level at which uplink signals are to be transmitted by a network amplifier in order to reach a base station. This determination may be a manual or an automated process. For example, a user may make the determination by measuring the surrounding environmental factors. Alternatively, the determination may be made by the network amplifier. The required signal level will typically have an inverse relationship to the signal level of the downlink signal received from a base station. In other words, as the level of the downlink signal increases, it is likely that the base station is within relatively close proximity to the cellular network amplifier or has not been significantly attenuated, and thus, the level of uplink signals being transmitted back to the base station (i.e., the “required signal level”) does not need to be as high.

After the required signal level is determined, the network amplifier receives 554 an uplink signal from a handset. The method 550 then applies 556 an amplification factor to the uplink signal, wherein the amplification factor is adjusted such that a level of the resulting amplified uplink signal satisfies the required signal level. In other words the amplification factor is established at a level such that after the uplink signal is amplified by the amplification factor, the uplink signal has a level that meets the signal level that is required for the transmitted uplink signals to reach the base station. For example, if the required signal level is relatively high, the amplification factor will typically be increased so that the transmitted cellular signal has sufficient power to be transmitted to the base station. Conversely, if the required signal level is relatively low, the amplification factor will typically be reduced by an amount necessary to prevent the transmitted amplified cellular signal from introducing interference into the surrounding cellular network. In one embodiment, the amplification factor may even be eliminated (i.e, set at a zero value) in order to ensure that interference is substantially eliminated.

The resulting amplified uplink signal is transmitted to the base station via the antenna at 558. Note that although the work “amplified” is used, the amplification factor may actually attenuate, or even eliminate the cellular signal where the amplification factor is less than one.

The methods 500 and 550 may further include applying a second amplification factor to the downlink signal (i.e., the signal received from the base station), and communicating the amplified downlink signal to at least one handset. The downlink signal may be communicated to the handset either via a second antenna.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network amplifier, comprising:
an antenna configured to receive a downlink signal from a base station;
a first variable gain module having an output coupled to the antenna and an input configured to receive an uplink signal from a handset, the first variable gain module applying a first amplification factor to the uplink signal to generate an adjusted uplink signal to be transmitted to the base station via the antenna;
a control circuit for determining a value of the first amplification factor, the value being a function of a level of the downlink signal, and being selected so that interference introduced into a cellular network by the transmission of the adjusted uplink signal is substantially eliminated.

2. The network amplifier as recited in claim 1, wherein the control circuit is further configured to determine the value of the first amplification factor so that the adjusted uplink signal has sufficient strength to be successfully transmitted to the base station.

3. The network amplifier as recited in claim 1, further comprising:
a second variable gain module coupled to the antenna and to the control circuit, the second variable gain module configured to apply a second amplification factor to the downlink signal, thereby generating an adjusted downlink signal to be communicated to the handset, wherein a level of the second amplification factor is determined by the control circuit.

4. The network amplifier as recited in claim 3, wherein the control circuit is further configured to determine the value of the second amplification factor so that the adjusted downlink signal has sufficient strength to be successfully communicated to the handset.

5. The network amplifier as recited in claim 3, wherein the values of the first and second amplification factors are approximately equal.

6. The network amplifier as recited in claim 3, wherein the value of the second amplification factor is independent from the value of the first amplification factor.

7. The network amplifier as recited in claim 3, wherein changes to the first and second amplification factors occur in identical incremental amounts.

8. The network amplifier as recited in claim 1, wherein the gain controller switches the first amplification factor to a non-zero value when the level of the downlink signal falls below a predetermined value, and switches the first amplification factor to a zero value when the level of the downlink signal exceeds the predetermined value.

9. The network amplifier as recited in claim 1, wherein the network amplifier communicates with the handset via a second antenna.

10. The system as recited in claim 1, wherein the control circuit comprises a detector for determining the level of the downlink signal and a gain controller for controlling the value of the first amplification factor.

11. A network amplifier, comprising:
an antenna for receiving a downlink signal from a base station;
a communication device for receiving an uplink signal from a handset;
a first variable gain module connected with the communication device, wherein the first variable gain module applies a first amplification factor to the uplink signal to generate an adjusted uplink signal, the adjusted uplink signal transmitted to the base station via the antenna;
a second variable gain module connected to the antenna, wherein the second gain module applies a second amplification factor to the downlink signal to generate an adjusted downlink signal, the adjusted downlink signal communicated to the handset via the communication device; and
a control circuit comprising:
a detector that receives the downlink signal from the antenna and determines a level of the downlink signal; and
a gain controller that reduces the first and second amplification factors applied by the first and second variable gain modules if the level of the downlink signal exceeds a predetermined value.

12. The network amplifier of claim 11, wherein the gain controller is further configured for reducing the first and second amplification factors to levels so that interference introduced into a cellular network by the transmission of the adjusted uplink and downlink signals is substantially eliminated.

13. The network amplifier of claim 11, wherein the gain controller is further configured for reducing the first and second amplification factors to a zero level if the level of the downlink signal exceeds a predetermined value.

14. The network amplifier of claim 11, wherein the gain controller is further configured for establishing the first amplification factor at a level so that the adjusted uplink signal has sufficient strength to be successfully transmitted to the base station.

15. The network amplifier of claim 11, wherein the gain controller is further configured for establishing the second amplification factor at a level so that the adjusted downlink signal has sufficient strength to be successfully communicated to the handset.

16. The system as recited in claim 11, wherein the values of both the first and second amplification factors are approximately equal.

17. The system as recited in claim 11, wherein the communication device communicates with the handset via a second antenna.

18. The system as recited in claim 11, wherein the network amplifier is configured to communicate with a plurality of handsets via the second antenna.

19. In a system that includes a wireless network including a base station able to communicate with multiple handsets, a method for communicating signals between the base station and one or more handsets using a network amplifier, the method comprising:
determining a required signal level at which an uplink signal is to be transmitted by a network amplifier in order to reach a base station;
receiving the uplink signal from at least one handset at the network amplifier;
applying an amplification factor to the uplink signal, wherein the amplification factor is adjusted such that a level of a resulting amplified uplink signal satisfies the required signal level; and
transmitting the resulting amplified uplink signal via an antenna to the base station.

20. The method as recited in claim 19, further comprising changing the amplification factor in the event that the required signal level does not exceed a predetermined value.

21. The method as recited in claim 20, further comprising setting the amplification factor to a zero-value in the event that the required signal level exceeds a predetermined value.

22. The method as recited in claim 19, further comprising setting a value of amplification factor so that interference introduced into a cellular network by the transmission of the adjusted uplink signal is substantially eliminated.

23. The method as recited in claim 19, wherein the required signal level increases as at least one of distance and attenuation between the antenna and the base station increases.
